(19) United States
(12) Patent Application Publication
(10) Pub. No.: US 2026/0233240 A1
(43) Pub. Date: Aug. 13, 2026

(54) COLD SPRAY APPARATUS USING A SELF-CLEANING AEROSPIKE NOZZLE

(71) Applicant: Continuum Dynamics, Inc., Ewing, NJ (US)

(72) Inventors: Balaji Muralidharan, Clinton, NJ (US); Elton M.A. Clark, Pennington, NJ (US)

(73) Assignee: Continuum Dynamics, Inc., Ewing, NJ (US)

(21) Appl. No.: 19/465,094

(22) Filed: Jan. 30, 2026

Related U.S. Application Data
(60) Provisional application No. 63/755,588, filed on Feb. 7, 2025.

(51) Int. Cl. B05B 7/14; C23C 24/04

(52) U.S. Cl. CPC B05B 7/1486; C23C 24/04

(57) ABSTRACT

A cold spray gun uses an aerospike nozzle having an aerospike with a portion inside a duct and another portion extending from the duct to a downstream end where the nozzle fluid flow is supersonic. A carrier gas introduced to the duct upstream of a particle feeder where particles are introduced to form a supersonic gas/particle stream. A layer of particles is deposited on the substrate by scanning it with the aerospike. To inhibit the adhesion of particles to the aerospike surface, a portion of the carrier gas is diverted to a bleed flow used to form a buffer layer of carrier gas on the aerospike surface. The deposited layer mimics the original substrate's mechanical properties by using particles of the same material. The spray gun has particular utility in repairing aerospace parts using nitrogen carrier gas instead of the more expensive helium used in prior cold spray guns.

### CROSS-REFERENCE TO RELATED APPLICATIONS

This application claims the benefit of U.S. provisional application No. 63/755,588 filed Feb. 7, 2025, the entire contents of said application being incorporated by reference as part of the present disclosure as if set out in full.

The cold spray apparatus in this disclosure uses a modified version of the spray gun in the inventors' co-pending U.S. non-provisional application Ser. No. 19/378,779 for COLD SPRAY APPARATUS USING AN AEROSPIKE NOZZLE (“the '779 application”). The entire contents of the '779 application are incorporated by reference as part of the present disclosure as if set out in full. The '779 application claims the benefit of U.S. provisional application No. 63/717,391 filed Nov. 7, 2024, the entire contents of which are also incorporated by reference as part of the present disclosure as if set out in full.

### BACKGROUND

One popular method of restoring a broken or degraded metal part directs a supersonic stream of gas with entrained micron-sized particles against the damaged part. Upon impact the particles deform and bond with the surface and each other, thereby depositing a layer that forms an integral structure with the substrate. The repaired part can then be machined to meet the dimensional tolerances of the original part. This method is called “cold spraying” because the process is performed at gas temperatures below the particles’ melting point, and as a result doesn't distort the part under repair, doesn't require subsequent heat treatment to alleviate residual stresses, and reduces oxidation issues that can compromise the bond between the particles and the target part.

The cold spray apparatuses and methods in the '779 application improved substantially over previously known cold spraying using the apparatus CS depicted schematically in FIG. 1, taken from https://www.coldsprayteam.com/cold-spray (Cold Spray Action Team, Worcester, MA). A gas control module GM holds a carrier gas such as nitrogen N2 or helium He. A fraction of the gas is fed to a powder feeder PF containing micron-sized particles of a material to be deposited on a substrate SB, such as the erosion-damaged surface of a nuclear reactor component. A heating unit HU heats another fraction of the gas to a temperature below the melting point of the particles, typically to about 400-600° C. The heated gas and the particles are combined in a mixer PM to create a working fluid comprising the gas and entrained particles.

This conventional cold spray apparatus uses a converging-diverging de Laval supersonic nozzle CD to accelerate the working fluid to a supersonic velocity. The inlet NI of the nozzle CD converges to a nozzle throat NT and then diverges from the throat to a nozzle outlet NO. Gas introduced to the nozzle inlet NI will flow at a subsonic velocity (that is, M<1, where M=v/c, v being the velocity of the working fluid and c being the velocity of sound in the fluid) until it reaches the throat NT. The nozzle is configured relative to the properties of the gas so that the flow chokes (M=1) at the nozzle throat and then travels supersonically (M>1) thereafter. The gas/particle stream GP directed toward the substrate forms a deposit DE that intimately bonds with the damaged target part, resulting in an integral structure which, if need be, can be machined to duplicate the original part.

Cold spraying has been successfully applied to many materials, and in many applications is cost effective compared to replacing a degraded part or using thermal repair methods. Repairing high value assets comprising metals of interest typically requires particle velocities nearly 1000 m/see, which is achievable using helium as the carrier gas. Other, cheaper gases such as nitrogen or air don't work as well because their acoustic speed is lower than helium, thus requiring the converging-diverging nozzle to achieve a higher Mach number to achieve the same particle velocity as helium. That is, since M=v/c, an increase of the speed of sound c in the gas will lower the value of M for a given gas velocity v. For example, one measure of the quality of the repair process is the porosity of the deposited material. A porosity of less than 1% can be achieved with a converging-diverging nozzle when the carrier gas is helium. But with many desirable candidates for cold-spray repair made of metals like titanium, aircraft-grade aluminum and steel, layers deposited with a converging-diverging nozzle typically exhibit higher porosities with nitrogen as the carrier gas. Villafuerte, J., Modern Cold Spray, Springer Intl. Publ. (2015), FIG. 11.8.

The cold spray apparatus in the '779 application addressed that problem by using a spray gun with a supersonic aerospike nozzle such as that shown schematically in FIG. 2, adapted from Raoelison, R. N., et al., “A Concept of Aerospike Nozzle for Cold Spray Additive Manufacturing: Towards a Potential Solution for Preventing the Issue of Clogging,” Thermal Spray 2023: Proceedings from the International Thermal Spray Conference, Quebec City, Canada, May 22-25, 2023, https://doi.org/10.31399/asm.cp.itsc2023p0229. The nozzle 10 comprises an annular shroud 12 and a central aerospike 14. The shroud 12 and the spike 14 have circular cross-sections along their length and are symmetric about a center line CL defining a nozzle x-axis 16. A working fluid is introduced into the upstream end 18 of the annular space between the shroud and a first portion of the aerospike, as indicated by the arrows 20. The working fluid comprises a carrier gas with entrained particles. The geometries of the shroud and aerospike form a duct 22 between the inner surface of the shroud and the outer surface of the aerospike. The duct 22 converges in the downstream direction (the positive x-axis) toward the downstream shroud outlet 24. The aerospike 12 includes a portion 26 that extends downstream from the shroud outlet 24 and tapers to a point 28. The shroud and aerospike are configured so that in the duct 22 the fluid accelerates from a subsonic velocity (M<1) at the nozzle inlet 18 to a throat 30 at the narrowest point of the flow path 22 where the flow is sonic (M=1, indicated by the dotted lines), and thereafter forms a supersonic (M>1) stream 32 of gas and entrained particles that extends to the downstream end 28 of the aerospike 14 and beyond.

The cold spray gun 100 shown in FIGS. 4-8 of the '779 application was tested in the configuration tabulated in FIGS. 9 and 10 of the '779 application by cold spraying aluminum powder onto four aluminum substrates under the tabulated conditions. The '799 projected the expected performance of the test samples in an operational setting by examining four properties: (1) deposition rate as indicated by the thickness of the deposited layer per spray gun pass; (2) sample microstructure using optical micrographs of sample cross-sections; (3) physical characteristics of the deposited layer surface using scanning electron microscopy; and (4) layer Vickers hardness and layer/substrate adhesion. The following table summarizes the test results.

TABLE 1

| | |
|---|---|
| Optical Micrographs | SEM |
| Uniform deposition | Extensive plastic deformation, |
| Strong bonding | complete absence of triple |
| Ultra-low porosity | junction voids |
| Excellent particle-to-particle | Absence of micro-porosity |
| bonding | |
| Deposition Rates | Adhesion and Hardness |
| High deposition rates at reduced | Hardness and adhesion values |
| operating pressures | exceeding values for known cold |
| Projected deposition rates | spray deposited layers with same |
| surpass cold spray systems | thickness |
| using He | Projected hardness value of |
| | deposited layer matching |
| | substrate |

The efficacy of the cold spray apparatuses and methods in the '779 application is thus well established. But the overall efficiency of the repair process can be affected by a tendency of the particles in the working fluid in the duct to deposit on flow surfaces of the spray gun under some circumstances. Over time, this can affect the quality of the deposited layer if the flow surfaces are not cleaned when these adhering particles are present to a degree affecting nozzle performance. That in turn results in down time and concomitantly affects operational efficiency.

### SUMMARY OF THE DISCLOSURE

One aspect of the present disclosure is a description of a high-efficiency, high-performance cold spraying system capable of using nitrogen or air instead of expensive and scarce helium for effective structural repair and additive manufacturing (“printing” of parts). The apparatuses and methods disclosed here address the same problems described in the '779 application encountered by cold spraying with converging-diverging de Laval nozzles, particularly when using nitrogen as the carrier gas. Likewise the cold spraying apparatuses and methods using the self-cleaning aerospike nozzle described in detail in the following sections can be expected to achieve the same advantages as those described in the '779 application

Those advantages include the ability to achieve higher Mach numbers than converging-diverging nozzles in cold spraying applications, thus making it possible to use cheaper carrier gases. Generally, a Mach number M≈3 is necessary to achieve the required flow velocity of 1000 m/see with nitrogen, as compared with a Mach number M≈1 required for helium. However, the flow from a converging-diverging nozzle at Mach numbers required to reach the flow velocity needed for nitrogen exhibit instabilities and losses that compromise the integrity of the deposited layer. Plus, the geometry of converging-diverging nozzles presents a challenge when repairing hard-to-reach areas. The narrow stream of an aerospike nozzle can be directed into areas such as in-hole regions and onto surfaces requiring specific spray angles that can be difficult to repair with the wider stream produced by converging-diverging nozzles.

An object of the cold spraying apparatuses and methods disclosed here is extending the operating time between intervals of maintenance and repair of the apparatus's cold spray gun by ameliorating the buildup of particles on the aerospike nozzle's flow surfaces.

### BRIEF DESCRIPTION OF THE DRAWINGS

The objects of the present disclosure will be better understood from the detailed description of embodiments of the claimed subject matter which follows below, when taken in conjunction with the accompanying drawings, wherein like numerals and letters refer to like features throughout. The following is a brief identification of the drawing figures used in the accompanying detailed description.

FIG. 1 is a schematic depiction of a known type of cold spraying apparatus using a converging-diverging de Laval nozzle.

FIG. 2 illustrates the geometry of a supersonic aerospike nozzle of the type used in the systems disclosed here.

FIG. 3 is an enlarged view of the throat area of the aerospike nozzle depicted in FIG. 2.

FIG. 4 is an isometric depiction of an embodiment of a cold spray gun using a self-cleaning aerospike nozzle in accordance with the description that follows.

FIG. 5 is a sectional view taken in the plane indicated by the lines 5-5 in FIG. 4.

FIG. 6 is a sectional view of the cold spray gun in FIG. 4 taken in the plane indicated by the lines 6-6 in FIG. 5.

FIG. 7 is a sectional view of the cold spray gun in FIG. 4 taken in the plane indicated by the lines 7-7 in FIG. 5.

FIG. 8 is an enlarged version of an optional flow swirler incorporated in the cold spray gun embodiment depicted in FIG. 4.

FIG. 9 is an enlarged view of the aerospike nozzle throat in the region labeled as such at line 9-9 of FIG. 5.

FIG. 10 is an enlarged view of the downstream terminal end of the aerospike in the region labeled as such in FIG. 5.

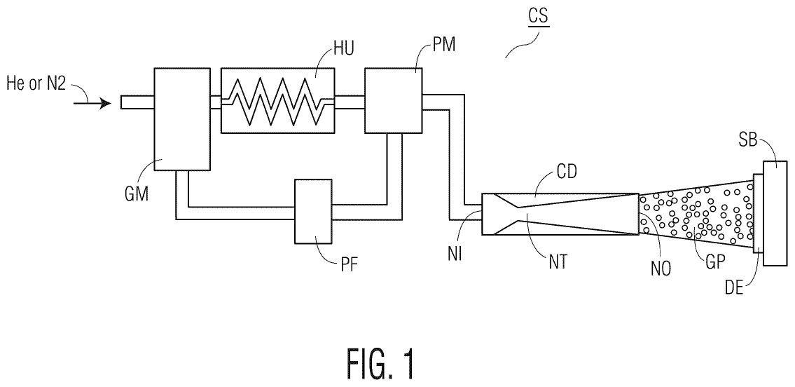

One skilled in the art will readily understand that the drawings are not strictly to scale, but nevertheless will find them sufficient, when taken with the detailed descriptions of preferred embodiments that follow, to make and use the claimed subject matter.

### DETAILED DESCRIPTION OF PREFERRED EMBODIMENTS

The detailed description that follows is intended to provide specific examples of particular embodiments illustrating various ways of implementing the claimed subject matter. It is written to take into account the level of knowledge of one of ordinary skill in the art to which the claimed subject matter pertains. Accordingly, certain details may be omitted as being unnecessary for enabling a person skilled in the art relating to the subjects disclosed here to realize the described embodiments. That person would have a degree in mechanical or aerospace engineering focusing on fluid mechanics, and would be familiar with advanced computer programs capable of applying mathematical algorithms for analyzing complex fluid flows, such as those based on three-dimensional computational fluid dynamics (CFD) programs.

In general, terms used throughout have the ordinary and customary meaning that would be ascribed to them by one of ordinary skill in the art. However, some of the terms used will be explicitly defined and that definition is meant to apply throughout. For example, the term “substantially” is sometimes used to indicate a degree of similarity of one property or parameter to another. This means that the properties or parameters are sufficiently similar in value to achieve the purpose ascribed to them in the context of the description accompanying the use of the term. Exact equivalence of many properties or parameters discussed here is not possible because of factors such as engineering tolerances and normal variations in operating conditions, but such deviations from an exact identity still fall within the meaning here of being “substantially” the same. Likewise, omission of the term “substantially” when equating two such properties or parameters does not imply that they are identical unless the context suggests otherwise. Similar considerations apply to the term “about,” which is sometimes used to indicate that the nominal value of a parameter or property can vary a certain amount as long as it produces the intended effect or result.

### I. Aerospike Nozzle Design

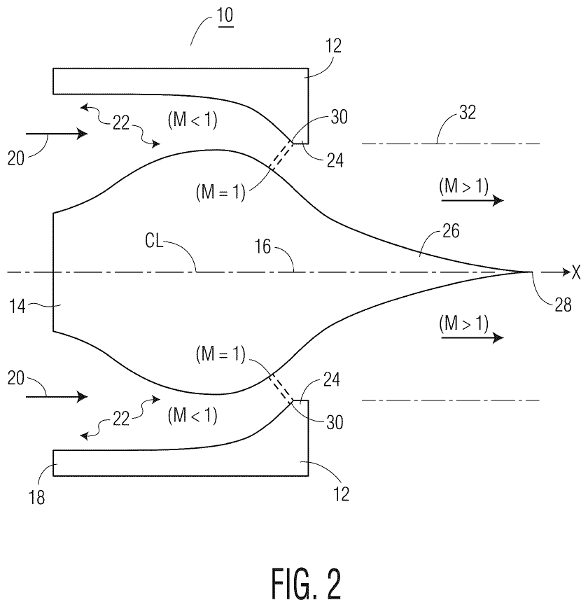

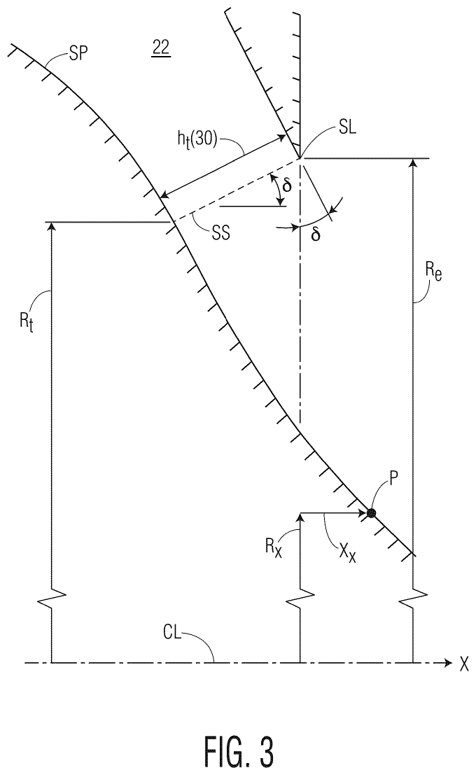

FIG. 3 models certain parameters used to define the geometry of an aerospike nozzle for the cold spray apparatuses and methods described here. The nozzle geometry is designed to provide the desired flow characteristics in consideration of the thermodynamic properties of the fluid and a design supersonic Mach number at the aerospike tip 28 (see FIG. 2). The FIG. 3 model is taken from Lee, C. C., “Fortran Programs for Plug Nozzle Design,” Technical Note R-41, Brown Engrg. Co., Huntsville, AL, March 1963 (hereafter “Lee”), incorporated by reference as part of the present disclosure as if set out in full. Provisional application No. 63/717,391 (hereafter “the '391 application”) explains how the iterative modeling process described in Lee was used to calculate a nozzle geometry that would result in a gas/particle stream velocity suitable for cold spraying using nitrogen as the carrier gas.

A principal design goal is to determine the radius Rx of the aerospike SP as a function of the axial distance X_{X}. Important geometric parameters are the radial distance Re from the nozzle axis to the shroud lip SL, the shroud angle δ between the nozzle axis and the sonic line SS at the shroud lip SL where M=1, the width hₜ of the throat 30 (the sonic line), and the radial distance Rt from the nozzle axis to the location of the sonic line at the aerospike. The design protocol begins with the selection of a target exit Mach number Mₑ to enable calculation of the area ratio Aₑ/Aₜ using equation (1) in the '391 application, where Aₑ is the nozzle exit area and Aₜ is the area of the throat 30. (Aₑ is calculated based on the chosen value of Mₑ and the specific heat ratio A of the carrier gas per equation (1) of the '391 application.) The target final Mach number is chosen in consideration of the desired exit velocity of the gas used for the cold spraying process. For example, if the gas is nitrogen the Mach number should be high enough to project the entrained particles at the surface of the target substrate at a fluid stream velocity of 1100-1200 m/see for a given gas temperature and pressure. (The actual particle velocity will be slightly lower.) The radial distance to any point P on the aerospike to achieve the target Mach Mₑ is calculated as a function of X_{X} by using equations (4) and (5) in the '391 application, where & is the expansion ratio (Aₑ/Aₜ). Lee describes the iterative process used to determine the nozzle geometry that will give the desired target exit Mach number Mₑ. The geometry of the subsonic flow region 22 for establishing the sonic line at the throat 30 is calculated according to the discussion at pages 10-16 of Lee.

Using the algorithms and computer program described in Lee, two cold spray guns with aerospike nozzles according to the above described protocol were constructed with the following geometries reported in the '779 application:

TABLE 1

| | Design No. 1 | | Design No. 2 | |
|---|---|---|---|---|
| Shroud angle (δ) | 26.9° | | 33.4° | |
| Shroud Lip Radius (Rₑ) | 3.0 | mm | 3.0 | mm |
| Throat Width (hₜ) | 0.17 | mm | 0.25 | mm |
| Throat area (Aₜ) | 3.14 × 10⁻⁶ | mm² | 4.64 × 10⁻⁶ | mm² |

| | | |
|---|---|---|
| Expansion ratio (ε) | 8.99 | 6.1 |
| Exit Mach No. (Mₑ) | 3.8 | 3.5 |

Either of those geometries can be used for the self-cleaning aerospike nozzle used in the cold spray gun described here. Other geometries suitable for other applications can be designed in accordance with the techniques just described.

II. Cold Spray Gun with Self-Cleaning Aerospike Nozzle

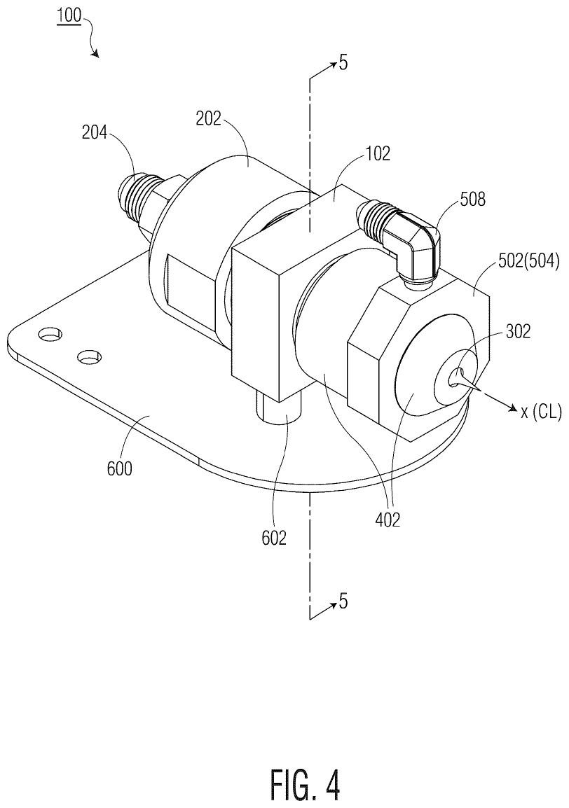

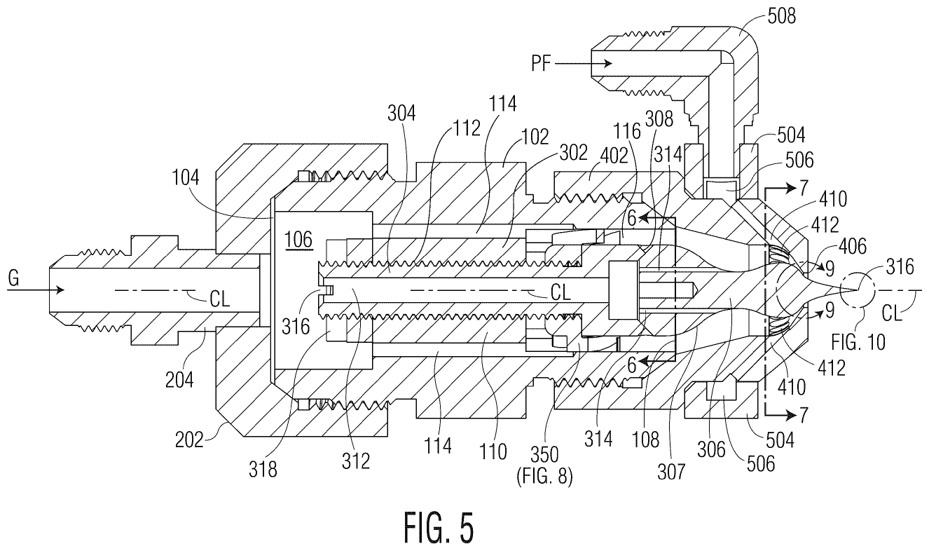

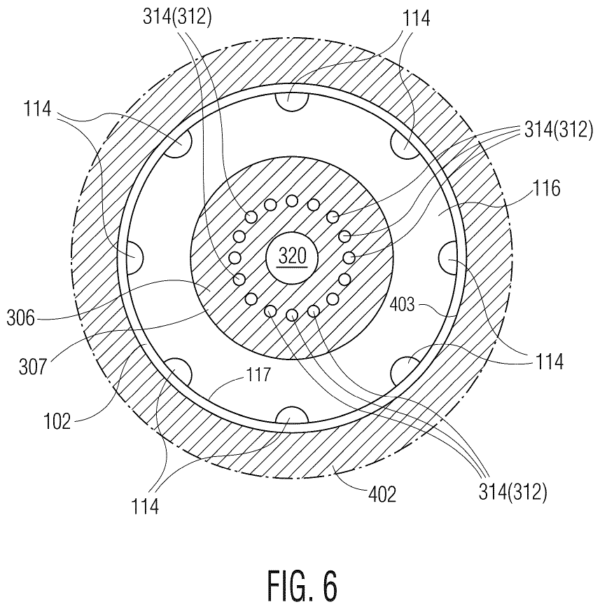

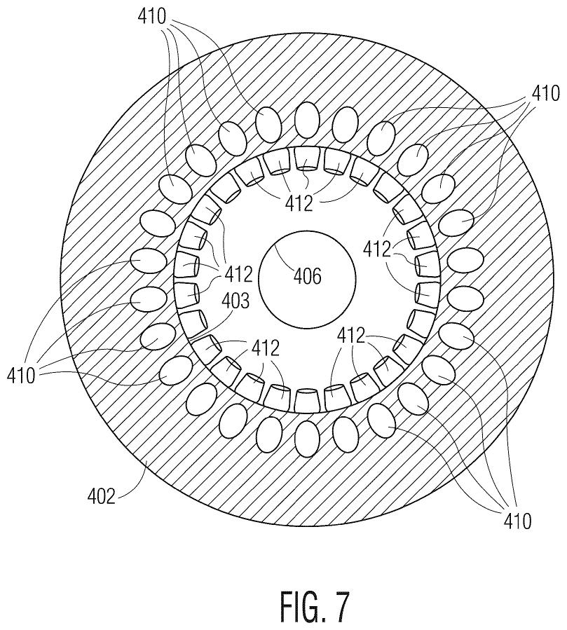

Referring to FIGS. 4 to 7, a cold spray gun 100 constructed according to the above described protocol is used to direct a stream of micron-size particles entrained in nitrogen toward a substrate (not shown) at supersonic velocities capable of forming a layer of material capable of performing the same in operation as the original substrate. Quantitatively stated, the layer will preferably have a porosity less than 0.2% and thick enough to achieve a bond strength of at least 90% of the original particle material. FIG. 4 is an isometric view of the apparatus. FIG. 5 is a sectional view taken in a plane normal to the x-direction (comprising the spray gun flow path centerline CL) at location 5-5 in FIG. 4. FIGS. 6 and 7 are sectional views of the cold spray gun 100 taken respectively at location 6-6 and location 7-7 in FIG. 5.

Principal components of the apparatus comprise a main body 102, an end cap 202, an aerospike assembly 302, a shroud 402 and a particle feeder 502. The spray gun 100 can be mounted to an optional adaptor plate 600 via a mounting boss 602 that in one embodiment can be integral with the main body 102. The adaptor plate 600 can be used to mount the spray gun to a conventional cold spray gun scanning apparatus (not shown) such as the VRC® Raptor™ system from VRC Metal Systems, LLC, of 600 N Ellsworth Rd., Box Elder, SD 57719. (The adaptor plate 600 and mounting boss 602 are omitted from the remaining figures for clarity.)

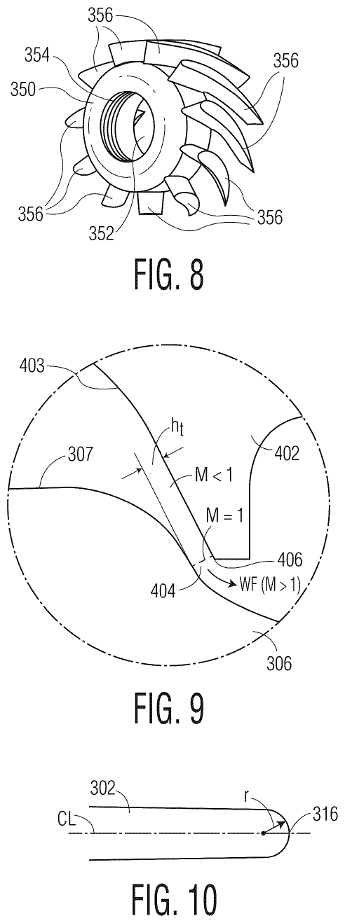

Referring initially to FIGS. 5 and 6, the main body 102 has a spray gun inlet 104 comprising an inlet chamber 106 and a main body outlet 108. The end cap 202 screws onto the inlet end of the main body 102 and includes a fitting 204 for introducing a carrier gas G to the inlet chamber 106. The main body further includes a central spike holder 110 with a threaded central bore 112. A first portion of a main flow path comprises eight separate circular main flow passages 114 spaced equidistantly around the spike holder 110. A second portion 116 of the main flow path comprises an annular duct formed between the outer surface 307 of the aerospike 306 and the inner surface 117 of the main body 102 and extending to the main body outlet 108. An optional flow swirler 350, shown separately in FIG. 8 and discussed in detail further below, is omitted from FIG. 6 to show the main flow passages 114.)

The aerospike assembly 302 includes a threaded aerospike support 304 and an aerospike 306. The aerospike support 304 screws into the threaded bore 110 of the spike holder 108. The aerospike 306 is securely attached to the aerospike support 304 at a circumferential weld 308. The annular space 307 between the outer cylindrical surface of the aerospike 306 and the coaxial circular inner surface 403 of the shroud 402 comprises a third portion of the main flow path extending to the lip 406 of the shroud 402 (See FIG. 9.) In the embodiment depicted in FIG. 5, the flow swirler 350 is screwed into place against a rear face of the aerospike support 304. The aerospike support 304 has a central bore comprising a bypass flow passage 312 for a portion of the carrier gas G introduced to the inlet chamber 106. The bypass flow passage further includes 16 bleed flow passages 314. An adjusting slot 316 at the end of the aerospike spike support allows the axial position of the aerospike to be adjusted and a lock nut 318 secures the aerospike in position during operation. A central blind bore 320 is an artifact of the process of manufacturing the aerospike 306 and performs no purpose in the primary function of the cold spray apparatus.

Referring to FIGS. 5 and 9 in particular, the shroud 402 screws onto the outlet end 108 of the main body into a position to form a spray gun outlet where the working fluid WF comprising the carrier gas and entrained particles exits. The shroud and aerospike at the spray gun outlet, shown enlarged in FIG. 9, are configured in accordance with the modeling protocol discussed in connection with FIGS. 2 and 3, whereby a first portion of the aerospike forms a working fluid flow path in the duct between the outer surface 307 of the aerospike 306 and the inner surface 403 of the shroud 402 and a second portion of the aerospike is tapered and extends from an outlet of the duct to a downstream tip 316. The geometries of the shroud and aerospike provide a fluid flow path whereby the working fluid WF introduced to the fluid flow path inlet at a Mach number M<1 accelerates to M=1 at a throat region 404 in the duct, and to a supersonic velocity M>1 from the fluid flow path outlet at the shroud lip 406 to the nozzle exit at the aerospike tip 316 and beyond. The width of the throat hₜ (see FIG. 3) can be adjusted by rotating the aerospike support using the adjusting slot 316. FIG. 10 shows the aerospike tip 316 enlarged from the scale of FIG. 5, with a spherical surface having a radius r generally made as small as possible within manufacturing limits to avoid flow losses as the working fluid flows over it. A preferred value of r is between about 0.001 in. and 0.003 in.

The particle feeder 502 includes a particle feed block 504 that forms an annular plenum 506 circumferentially around the shroud 402. A particle feed fitting 508 secured to the feed block 504 introduces a particle feed PF to the plenum 506. As shown more clearly in FIG. 7, from which the aerospike 306 has been omitted for ease of illustration), the shroud has 26 feeder passages 410 equally spaced around the circumference of the shroud 402 connected at one end to the plenum 508. The other end of the feeder passages are connected with the duct between the inner surface of the shroud and the outer surface of the aerospike via 26 corresponding feeder openings 412 upstream of the throat region 404 for introducing the particle feed PF into the flow path to create the working fluid WF.

Referring to FIG. 8, the flow swirler 350 can be used to add a circumferential component to the discrete streams exiting from the flow passages 114 into the annular flow path second portion 116. The swirler includes a central hub 352 with internal threads 354 that screw onto the aerospike support as shown in FIG. 5. Plural airfoil-shaped vanes 356 turn the flow to impart a circumferential component to the gas/particle mixture that increases its residence time in the fluid flow path with the goal of achieving a higher velocity of the particle stream at the duct exit, thereby enhancing the mechanical properties of the deposited layer. (See Table 1.) Imparting a circumferential component to the flow also improves its circumferential uniformity before it reaches the particle feeder openings 412 in turn improves the uniformity of the working flow though the nozzle throat and further enhances the properties of the layer deposited on the substrate.

In operation, a carrier gas G is introduced via the fitting 204 into the inlet chamber 106. In a typical application the carrier gas is nitrogen (N2) at a temperature of 200° C. to 600° C. and pressure of 400 psi to 950 psi. A main portion of the carrier gas enters the circular passages 114 of the main flow path and a bypass portion of the carrier gas enters the bypass flow passage 312 in the aerospike support 304. The bypass portion of the carrier gas is introduced into the third portion of the main flow path via the bleed passages 314. The ratio of the amount of the overall flow rate of the carrier gas to the amount used as bleed flow depends on the temperature and pressure of the carrier gas and the number and size of the bleed passages. In a preferred embodiment the spray gun is constructed so that a bleed fraction of the carrier gas introduced through the fitting 204 is diverted to the bleed passages 314 via the bypass flow passage 312 while a main fraction flows through the main flow path. In preferred embodiments, \dot{m}_{bleed}/\dot{m}ₘₐᵢₙ will typically be about 15% to 20%, where:

$${\dot{m}}_{bleed} = {n}_{b} * {ρ}_{cg} * {v}_{b} * π * {r}_{b}^{2}$$

wherein n_{b} is the number of bleed passages 314, ρ_{cg} is the density of the carrier gas, and r_{b} is the radius of the bleed passages

A concentrated feed of particles PF is introduced through the fitting 508 and flows via the plenum 506 and the feeder openings 412 into the third portion of the main flow path. The particles in the particle feed PF mix with the carrier gas in the main flow path to form the working fluid WF, which is accelerated to supersonic velocity and projected against a target substrate as described previously. The bleed passages 314 introduce the bypass flow into the main flow path upstream of the axial location of the feeder openings to form a thin layer of carrier gas surrounding the outer surface of the aerospike. Preferably, the bleed passages 314 open to the main flow path at a bleed location where their radially inner surfaces are tangent to the outer surface of the aerospike as seen in FIG. 5 to promote the formation of a carrier gas buffer layer substantially free of particles along the aerospike surface at the particle feed openings. This purpose of the bleed flow will affect the value of \dot{m}_{bleed}/\dot{m}ₘₐᵢₙ for any particular application. Although a higher percentage of bleed flow can enhance self-cleaning it can cause flow separation as the working fluid gas/particle mixture is accelerated in the nozzle. As a result, the exit velocity of the working fluid and the properties of the deposited layer will be affected. (See Table 1.)

The buffer layer of carrier gas envelopes the surface of the aerospike and prevents or inhibits the particles in the particle fed through the feeder openings 412 from directly impacting the aerospike surface 307. The bleed flow inhibits unwanted particle deposition on the aerospike surface and reduces particle buildup, enabling unobstructed flow through the nozzle to be sustained for longer periods and providing more consistent performance over longer periods. In a preferred embodiment, the mass flow rate of the particle feed \dot{m}_{pf} will be between about 5% and 10% of the combined mass flow rate \dot{m}_{combined}=\dot{m}ₘₐᵢₙ+\dot{m}_{bleed}. In general, the particle feed mass flow rate will be the minimum amount required to transport the particles for a given spray gun geometry,

The particles will typically be made of the same material as the substrate, examples being a metal such as an aerospace-grade aluminum alloy, a copper-nickel alloy, titanium, stainless steel or an Inconel® alloy. The spray gun 100 is particularly well adapted for repairing parts made of high strength aerospace-grade aluminum alloys such as AL-7075, AL 6061 and AL 7050. The particle feed typically at a slightly higher pressure than the carrier gas feed G and at room temperature (~20° C.). Particles are fed into the fitting 508 at a specified rate up to 30 μm/min. For most applications, cold spraying equipment manufacturers typically specify carrier gas feed rates between 1000 and 1500 standard liters per minute (SLPM) and powder stream feed rates between 100 and 200 SLPM with a particle feed rate about 5 μm/min. The particles are sourced so that substantially all of them are smaller than the width hₜ of the nozzle throat. For example, batches of particles are typically provided according to specifications that give a size distribution in terms of the percentages of the particles having a particular size. A suitable particle specification would call for a batch of spherical particles 90% of which have a diameter less than 0.046 mm. A preferred particle specification would call for 90% of the particles to have a diameter no more than one-half of the throat width. In preferred embodiments the throat width hₜ would typically be between 0.25 mm and 0.35 mm and the average size of the particles would be 30 microns, with 90% being less than 50 microns. Expressed more generally in terms of the radius Re of the shroud lip (see FIG. 3), the width hₜ of the throat in preferred embodiments will be between 0.125Rₑ and 0.083Re. The particle size can be adjusted accordingly.

Likewise, the adjusting slot 316 at the upstream end of the aerospike spike support 304 can be used to adjust the throat width hₜ during final testing of the performance of the spray gun before using it in a production setting. This is important because the nozzle geometry is typically designed using mathematical algorithms, but final adjustment of the axial position of the aerospike 306 may be necessary to optimize spray gun performance.

### III. Summary And Conclusions

The novel cold spray apparatus using an aerospike nozzle and the methods of using it as described in the present disclosure can achieve high performance coatings using nitrogen as the carrier gas, while minimizing particle adhesion to the nozzle surfaces and reducing downtime for cleaning. It is believed that the results of the tests using an aerospike nozzle for cold spray applications reported in the '391 application equally demonstrate the efficacy of the disclosed self-cleaning spray gun in producing high-quality, high-strength cold spray coatings with very low porosity and high deposition rates that mimic salient mechanical properties of the original substrate. Those test results also indicate the spray gun's potential to match or even surpass the performance of prior helium-based cold spray systems in important aspects.

Those skilled in the art will readily recognize that only selected preferred embodiments of the methods and constructions and their concomitant advantages have been depicted and described, and it will be understood that various changes and modifications can be made other than those specifically mentioned above without parting from the spirit and scope of inventions described here and defined solely by the claims that follow.

What is claimed is:

1. A spray gun for accelerating a working fluid comprising a carrier gas having solid particles entrained therein to a supersonic velocity for depositing said particles on a substrate, said spray gun comprising an aerospike nozzle including a duct and an aerospike with a first portion disposed in said duct to form a working fluid flow path between an inner surface of said duct and an outer surface of said aerospike and a second portion tapering from an outlet of said duct to a downstream end, wherein:
said inner surface of said duct wall and said outer surface of said first portion of said aerospike are configured to accelerate fluid introduced to a working fluid flow path inlet at a Mach number M<1, to M=1 at a throat region between said fluid flow path inlet and a working fluid flow path outlet, and to a supersonic velocity M>1 at said working fluid flow path outlet, said second portion of said aerospike being configured to maintain said working fluid at a supersonic velocity from said working fluid flow path outlet to a nozzle exit at said downstream end of said second portion of said aerospike;
said spray gun further comprises a main flow path for a main fraction of said carrier gas, a bypass flow path for a bleed fraction of said carrier gas, and a particle feeder for introducing particles into said fluid flow path at a particle feed location upstream of said throat region to form said working fluid; and
said bypass flow path includes bleed openings for introducing said bleed fraction to said main flow path upstream of said particle feed location for creating a buffer layer of carrier gas on the surface of said aerospike in said working fluid flow path.

2. The spray gun of claim 1, wherein said inner surface of said duct is circular in cross-section from said fluid flow path inlet to said fluid flow path outlet, said first and second portions of said aerospike are circular in cross-section, and said duct and said aerospike have a common centerline.

3. The spray gun of claim 2, wherein said second portion of said aerospike is configured so that the Mach number Mₑ at the nozzle exit is sufficient to cause said working fluid to travel at a terminal velocity whereby said particles deposited on said substrate form a layer of material capable of performing the same in operation as the original substrate.

4. The spray gun of claim 2, wherein said aerospike includes a plurality of internal bleed passages substantially equally spaced circumferentially for introducing said bleed fraction to said main flow path via corresponding said bleed openings at a bleed location tangent to the aerospike surface to promote the formation of a buffer layer of carrier gas on said aerospike surface.

5. The spray gun of claim 4, wherein \dot{m}ₘₐᵢₙ is the mass flow rate of the main fraction of the carrier gas, \dot{m}_{bleed} is the mass flow rate of the bleed fraction of the main flow rate, \dot{m}_{bleed}/\dot{m}ₘₐᵢₙ≈15% to 20%.

6. The spray gun of claim 4, wherein said main fluid flow path includes a first portion comprising a plurality of main flow passages equally spaced circumferentially around said centerline of said duct and a second annular portion downstream of said first portion and upstream of said bleed location.

7. The spray gun of claim 6, further comprising flow swirler means disposed in said second portion of said main flow path for inducing a circumferential component in the fluid flow in said second portion of said main flow passage.

8. The spray gun of claim 7, wherein said flow swirler means comprises a plurality of airfoil shaped vanes disposed circumferentially in said second annular portion of said main flow path for turning the main fraction of said carrier gas circumferentially.

9. The spray gun of claim 2 includes a particle feeder comprising:
an annular plenum surrounding said duct for accepting a particle feed comprising a mixture of said carrier gas and said particles; and
a plurality of feeder passages equally spaced circumferentially around said centerline and opening into said duct for introducing said particle feed from said plenum into said main fluid flow path downstream of said bleed location and upstream of said throat region to form said working fluid.

10. The spray gun of claim 9 wherein \dot{m}ₘₐᵢₙ is the mass flow rate of the main fraction of the carrier gas, \dot{m}_{bleed} is the mass flow rate of the bleed fraction of the carrier gas, and the mass flow rate of the particle feed \dot{m}_{pf} is between about 5% and 10% of the combined mass flow rate \dot{m}_{combined}=\dot{m}ₘₐᵢₙ+\dot{m}_{bleed}.

11. The spray gun of claim 10, wherein said aerospike includes a plurality of internal bleed passages substantially equally spaced circumferentially for introducing said bleed fraction to said main flow path via corresponding said bleed openings at a bleed location tangent to the aerospike surface to promote the formation of a buffer layer of carrier gas on said aerospike surface.

12. The spray gun of claim 11, wherein \dot{m}ₘₐᵢₙ is the mass flow rate of the main fraction of the carrier gas, \dot{m}_{bleed} is the mass flow rate of the bleed fraction of the main flow rate, and \dot{m}_{bleed}/\dot{m}ₘₐᵢₙ is about 15% to 20%.

13. The spray gun of claim 2, wherein said working fluid is nitrogen (N₂) and a terminal velocity of said working fluid at said nozzle exit is between about 1100 m/see and 1200 m/sec.

14. The spray gun of claim 13, wherein said particles and said substrate are the same material selected from at least one of the aerospace-grade aluminum alloys AL-7075, AL 6061 and AL 7050.

15. The spray gun of claim 2, wherein the ratio of a width hₜ of said throat region normal to the flow therethrough to a radius Rₑ of said working fluid flow path outlet is between about 0.125 and 0.083.

16. The spray gun of claim 15, wherein the width hₜ of said throat region is between about 0.25 mm and 0.35 mm.

17. The spray gun of claim 16, wherein the average size of the particles is 30 microns and 90% of said particles are less than 50 microns.

18. The spray gun of claim 16, wherein said particle feeder introduces said particles at a particle feed rate up to 30 μm/min.

19. The spray gun of claim 1, wherein said downstream end of said aerospike is substantially spherical with a radius r between about 0.001 in. and 0.003 in.

20. The spray gun of claim 1, further comprising a spray gun body, wherein said aerospike is mounted to said spray gun body for relative movement changing the width of said throat region normal to the flow therethrough.

21. The spray gun of claim 20, wherein said aerospike is threaded into spray gun body for changing the width of said throat by rotating said aerospike about said centerline to change the axial position thereof.

22. A method of repairing a metallic article comprising:
providing the spray gun of claim 1;
introducing said carrier gas into a spray gun inlet in fluid communication with said main flow path and said bypass flow path;
thereafter introducing a particle feed comprising said carrier gas having said particles entrained therein upstream of said throat region; and
scanning said article with the downstream end of the aerospike to form a layer of the particle material on said article.

23. The method as in claim 22, wherein said particles and said article are the same material selected from at least one of the aerospace-grade aluminum alloys AL-7075, AL 6061 and AL 7050.

24. The method of claim 22, wherein said second portion of said aerospike is configured so that the Mach number Me at the nozzle exit is sufficient to cause said working fluid to travel at a terminal velocity between 1100 m/see and 1200 m/see and said layer has a porosity less than 0.2% and a thickness achieving a bond strength of at least 90% of the original part material.
